(19) United States
(12) Patent Application Publication
(10) Pub. No.: US 2025/0147727 A1
(43) Pub. Date: May 8, 2025

(54) MULTIPLIER AND ITS COMPUTATIONAL PROCESSING METHOD

(71) Applicant: GLENFLY TECH CO., LTD. (SHANGHAI), Shanghai (CN)

(72) Inventors: Yaohui ZENG, Shanghai (CN); Yuqin Yu, Shanghai (CN); Renyu Bian, Shanghai (CN); Huaisheng Zhang, Shanghai (CN)

(73) Assignee: GLENFLY TECH CO., LTD. (SHANGHAI), Shanghai (CN)

(21) Appl. No.: 18/939,775

(22) Filed: Nov. 7, 2024

(30) Foreign Application Priority Data
Nov. 7, 2023 (CN) 202311475191.2

(51) Int. Cl. G06F 7/533; G06F 7/50

(52) U.S. Cl. CPC G06F 7/5334; G06F 7/50

(57) ABSTRACT

According to an aspect of the disclosure, a computational processing method of multiplier, performed by a processor chip, includes: obtaining, based on n first operands a[k], a first operating part A including BIT(A) bits; obtaining x first encoded data Enc[m] by assigning a lowest bit of consecutive three-bit numbers spanning two adjacent first operands a[k] and a[k−1] to 0, and performing Booth-encoding on the first operating part A; obtaining, based on n second operands b[k], n corresponding second operating parts B[k], each of which has BIT(B) bits; obtaining x partial products based on multiplying the x first encoded data Enc[m] with the n corresponding second operating parts; obtaining an accumulation result based on accumulating the x partial products; obtaining a multiplication result based on truncating the accumulation result; wherein, n, k, x, and m are integers, and wherein 0≤k<n, and 0≤m<x.

### CROSS-REFERENCE TO RELATED APPLICATION

This application claims priority from Chinese Patent Application No. 202311475191.2, filed with the China National Intellectual Property Administration on Nov. 7, 2023, the disclosure of which is incorporated herein by reference in its entirety.

### FIELD

The present disclosure relates to a processor chip; and more particularly, to a multiplier and a processing method.

### BACKGROUND

In existing processor chips, multiplication operations in various numerical operations may be highly resource intensive. For example, multipliers may only be designed to multiply two numbers. Thus, to parallelize multiply accumulate operations (MAC) of multiple numbers, multiple multipliers and an accumulator with multiple inputs must be implemented, resulting in greater resource consumption. Moreover, different multiply accumulate operations and multiplication operations may require different multipliers and accumulation units to be manufactured, resulting in increased costs and resources.

### SUMMARY

According to an aspect of the disclosure, a computational processing method of multiplier, performed by a processor chip, includes: obtaining, based on n first operands a[k], a first operating part A including BIT(A) bits; obtaining x first encoded data Enc[m] by assigning a lowest bit of consecutive three-bit numbers spanning two adjacent first operands a[k] and a[k−1] to 0, and performing Booth-encoding on the first operating part A; obtaining, based on n second operands b[k], n corresponding second operating parts B[k], each of which has BIT(B) bits; obtaining x partial products based on multiplying the x first encoded data Enc[m] with the n corresponding second operating parts; obtaining an accumulation result based on accumulating the x partial products; obtaining a multiplication result based on truncating the accumulation result; wherein, n, k, x, and m are integers, and wherein 0≤k<n, and 0≤m<x.

The obtaining the first operating part A may include: obtaining the n first operands a[k] and setting the first operating part A, wherein the n first operands a[k] each have BIT(a[k]) bits and are signed numbers, the first operating part A has BIT(A) bits, and BIT(a[k]) is even and satisfies Σ₀ⁿ⁻¹BIT(a[k])≤BIT(A); arranging the n first operands a[k] in descending order from largest to smallest according to a value of label k, wherein a first operand a[k] in a first position is adjacent to a first operand a[k−1] in a second position; arranging the n first operands a[k] in descending order from highest bit a[k][BIT(a[k])−1] to lowest bit a[k][0]; starting from a lowest bit in the BIT(A) bits of the first operating part A, inserting the first operand a[k] corresponding to the label k into each bit BIT(A[k]) of the BIT(A) bits in sequence; determining a magnitude relationship between BIT(A) and a sum of bits of the n first operands Σ₀ⁿ⁻¹BIT(a[k]); filling, based on Σ₀ⁿ⁻¹BIT(a[k]) being less than BIT(A), highest bit a[n−1][BIT(a[n−1])−1] of first operand a[n−1] as a sign bit before a highest bit a[n−1] of the n first operands; and outputting the first operating part A based on Σ₀ⁿ⁻¹BIT(a[k]) being equal to BIT(A).

The obtaining the x first encoded data Enc[m] may include: determining parity of BIT(A); supplementing, based on BIT(A) being odd, highest bit a[n−1][BIT(a[n−1])−1] of the first operand a[n−1] as a sign bit before a highest bit of the first operating part A; supplementing, based on BIT(A) being even, 0 after a lowest bit of the first operating part A to obtain intermediate operand C which has BIT(C) bits; from the BIT(C) bits of the intermediate operand C, continuously selecting three bits every two bits interval as the consecutive three-bit numbers to be encoded; determining whether the consecutive three-bit numbers spans two consecutive first operands a[k] and a[k−1]; assign, based on the consecutive three-bit numbers spanning the two consecutive first operands a[k] and a[k−1], a lowest bit a[k−1][BIT(a[k])−1] in the consecutive three-bit numbers to 0; and obtaining, based on the consecutive three-bit numbers not spanning the two consecutive first operands a[k] and a[k−1], the x first encoded data Enc[m] based on: referring to a Booth-encoding truth-value table, and performing truth-value mapping on the consecutive three-bit numbers, wherein, x=(BIT(A)+1)/2 based on BIT(A) being odd, and x=BIT(A)/2 based on BIT(A) being even.

The obtaining the n corresponding second operating parts B[k] may include: obtaining the n second operands b[k] and setting the second operating part B[k] corresponding to each second operand b[k], wherein, the second operands b[k] each have BIT(b[k]) bits, and the second operating parts B[k] each have BIT(B) bits, and wherein BIT(b[k])≤BIT(B) when k=n−1, and BIT(b[k])+Σᵢ₌ₖⁿ⁻²BIT(a[i])≤BIT(B) when 0≤k≤n−2; determining whether the second operand b[k] is a signed number; supplementing, based on the second operand b[k] being a signed number, 0 as a sign bit before a highest bit of the second operand b[k], and correspondingly adding 1 to the number of BIT(B) bits in the second operating part B[k]; determining, based on the second operand b[k] not being a signed number, a magnitude of k; supplementing, based on 0≤k≤n−2, Σᵢ₌ₖⁿ⁻²BIT(a[i]) after a lowest bit of the second operand b[k]; supplementing, based on k=n−1, all bits before the highest bit of the second operand b[k] with sign bit b[k][BIT(b[k])−1]; and outputting n second operating parts B[k].

The obtaining the x partial products may include: querying the consecutive three-bit numbers corresponding to the x first encoded data Enc[m] before performing truth-value mapping; confirming the first operand a[k] corresponding to the consecutive three-bit numbers according to a value of the label k corresponding to each bit in the consecutive three-bit numbers; determining whether the consecutive three-bit numbers spans two consecutive first operands a[k] and a[k−1]; specifying, based on the consecutive three-bit numbers spanning two consecutive first operands a[k] and a[k−1], that the consecutive three-bit numbers correspond to the first operand a[k]; confirming, based on the consecutive three-bit numbers not spanning two consecutive first operands a[k] and a[k−1], the n second operating parts B[k] corresponding to the x first encoded data Enc[m] according to the first operands a[k] corresponding to the consecutive three-bit numbers; and multiplying the x first encoded data Enc[m] with the n second operating parts B[k] to obtain the x partial products.

The obtaining the multiplication result may include: confirming the accumulation result has BIT(D) bits and a maximum number of bits BIT(E) for the multiplication result according to the BIT(A) and the BIT(B); starting from the lowest bit in BIT(D) bits of the accumulation result, and discarding Σᵢ₌₀ⁿ⁻²BIT(a[i]) bits; starting from the (Σᵢ₌₀ⁿ⁻²BIT(a[i])+1)-th bit in BIT(D) bits of the accumulation result, truncating a number of bits with the maximum number of bits BIT(E) from a low bit to a high bit as the multiplication result; and outputting the multiplication result.

According to an aspect of the disclosure, a multiplier of a processor chip, includes: first processing circuitry configured to obtain, based on n first operands a[k], a first operating part A including BIT(A) bits; encoding circuitry configured to obtain x first encoded data Enc[m] by assigning a lowest bit of consecutive three-bit numbers spanning two adjacent first operands a[k] and a[k−1] to 0, and performing Booth-encoding on the first operating part A; second processing circuitry obtain, based on n second operands b[k], n corresponding second operating parts B[k], each of which has BIT(B) bits; multiplying circuitry configured to obtain x partial products based on multiplying the x first encoded data Enc[m] with the n corresponding second operating parts; accumulation circuitry configured to obtain an accumulation result based on accumulating the x partial products; and truncation circuitry configured to obtain a multiplication result based on truncating the accumulation result, wherein, n, k, x, and m are integers, and wherein 0≤k<n, 0≤m<x.

The first processing circuitry may be configured to: obtain the n first operands a[k] and setting the first operating part A, wherein the n first operands a[k] each have BIT(a[k]) bits and are signed numbers, the first operating part A has BIT(A) bits, and BIT(a[k]) is even and satisfies Σ₀ⁿ⁻¹BIT(a[k])≤BIT(A); arrange the n first operands a[k] in descending order from largest to smallest according to a value of label k, wherein a first operand a[k] in a first position is adjacent to a first operand a[k−1] in a second position; arrange the n first operands a[k] in descending order from highest bit a[k][BIT(a[k])−1] to lowest bit a[k][0]; start from a lowest bit in the BIT(A) bits of the first operating part A, inserting the first operand a[k] corresponding to the label k into each bit BIT(A[k]) of the BIT(A) bits in sequence; determine a magnitude relationship between BIT(A) and a sum of bits of the n first operands Σ₀ⁿ⁻¹BIT(a[k]); fill, based on Σ₀ⁿ⁻¹BIT(a[k]) being less than BIT(A), highest bit a[n−1][BIT(a[n−1])−1] of first operand a[n−1] as a sign bit before a highest bit a[n−1] of the n first operands; and output the first operating part A based on being equal to BIT(A).

The encoding circuitry may be configured to: determine parity of BIT(A); supplement, based on BIT(A) being odd, highest bit a[n−1][BIT(a[n−1])−1] of the first operand a[n−1] as a sign bit before a highest bit of the first operating part A; supplement, based on BIT(A) being even, 0 after a lowest bit of the first operating part A to obtain intermediate operand C which has BIT(C) bits; from the BIT(C) bits of the intermediate operand C, continuously selecting three bits every two bits interval as the consecutive three-bit numbers to be encoded; determine whether the consecutive three-bit numbers spans two consecutive first operands a[k] and a[k−1]; assign, based on the consecutive three-bit numbers spanning the two consecutive first operands a[k] and a[k−1], a lowest bit a[k−1][BIT(a[k])−1] in the consecutive three-bit numbers to 0; and obtain, based on the consecutive three-bit numbers not spanning the two consecutive first operands a[k] and a[k−1], the x first encoded data Enc[m] based on: referring to a Booth-encoding truth-value table, and performing truth-value mapping on the consecutive three-bit numbers, wherein, x=(BIT(A)+1)/2 based on BIT(A) being odd, and x=BIT(A)/2 based on BIT(A) being even.

The second processing circuitry may be configured to: obtain the n second operands b[k] and setting the second operating part B[k] corresponding to each second operand b[k], wherein, the second operands b[k] each have BIT(b[k]) bits, and the second operating parts B[k] each have BIT(B) bits, and wherein BIT(b[k])≤BIT(B) when k=n−1, and BIT(b[k])+Σᵢ₌ₖⁿ⁻²BIT(a[i])≤BIT(B) when 0≤k≤n−2; determine whether the second operand b[k] is a signed number; supplement, based on the second operand b[k] being a signed number, 0 as a sign bit before a highest bit of the second operand b[k], and correspondingly adding 1 to the number of BIT(B) bits in the second operating part B[k]; determine, based on the second operand b[k] not being a signed number, a magnitude of k; supplement, based on 0≤k≤n−2, Σᵢ₌ₖⁿ⁻²BIT(a[i]) 0 s after a lowest bit of the second operand b[k]; supplement, based on k=n−1, all bits before the highest bit of the second operand b[k] with sign bit b[k][BIT(b[k])−1]; and output n second operating parts B[k].

The multiplying circuitry may be configured to: query the consecutive three-bit numbers corresponding to the x first encoded data Enc[m] before performing truth-value mapping; confirm the first operand a[k] corresponding to the consecutive three-bit numbers according to a value of the label k corresponding to each bit in the consecutive three-bit numbers; determine whether the consecutive three-bit numbers spans two consecutive first operands a[k] and a[k−1]; specify, based on the consecutive three-bit numbers spanning two consecutive first operands a[k] and a[k−1], that the consecutive three-bit numbers correspond to the first operand a[k]; confirm, based on the consecutive three-bit numbers not spanning two consecutive first operands a[k] and a[k−1], the n second operating parts B[k] corresponding to the x first encoded data Enc[m] according to the first operands a[k] corresponding to the consecutive three-bit numbers; and multiply the x first encoded data Enc[m] with the n second operating parts B[k] to obtain the x partial products.

The truncation circuitry may be configured to: confirm the accumulation result has BIT(D) bits and a maximum number of bits BIT(E) for the multiplication result according to the BIT(A) and the BIT(B); start from the lowest bit in BIT(D) bits of the accumulation result, and discarding Σᵢ₌₀ⁿ⁻²BIT(a[i]) bits; start from the (Σᵢ₌₀ⁿ⁻²BIT(a[i])+1)-th bit in BIT(D) bits of the accumulation result, truncate a number of bits with the maximum number of bits BIT(E) from a low bit to a high bit as the multiplication result; and output the multiplication result.

The encoding circuitry may include multiple encoders including zero clearing circuitry and mappers, wherein first two bit numbers of the consecutive three-bit numbers are input into the mapper, and a last bit number is input into the zero clearing circuitry, and wherein the last bit number is zeroed and a value of 0 is input into the mapper based on the consecutive three-bit numbers spanning two adjacent first operands a[k] and a[k−1], otherwise, an original value of the last bit number is input into the mapper.

The second processing circuitry may include multiple selection fillers, wherein a selection filler may be configured to process a second operand, and wherein the multiple selection fillers may be configured to synchronously or asynchronously process the second operand.

The multiple selection fillers may be configured to synchronously process the second operand, and wherein the multiplier may be configured to obtain the second operating part B[k] by filling the n second operands b[k] and selecting the second operand b[k] to be processed through the multiple selection fillers.

The multiple selection fillers may be configured to asynchronously process the second operand, and the multiplier may be configured to obtain the second operating part B[k] by selecting the second operand b[k] to be processed and filling the second operand b[k] through the corresponding selection filler.

According to an aspect of the disclosure, a processor chip includes a multiplier, wherein the multiplier includes: first processing circuitry configured to obtain, based on n first operands a[k], a first operating part A including BIT(A) bits; encoding circuitry configured to obtain x first encoded data Enc[m] by assigning a lowest bit of consecutive three-bit numbers spanning two adjacent first operands a[k] and a[k−1] to 0, and performing Booth-encoding on the first operating part A; second processing circuitry obtain, based on n second operands b[k], n corresponding second operating parts B[k], each of which has BIT(B) bits; multiplying circuitry configured to obtain x partial products based on multiplying the x first encoded data Enc[m] with the n corresponding second operating parts; accumulation circuitry configured to obtain an accumulation result based on accumulating the x partial products; and truncation circuitry configured to obtain a multiplication result based on truncating the accumulation result, wherein, n, k, x, and m are integers, and wherein 0≤k<n, 0≤m<x.

The encoding circuitry may include multiple encoders including zero clearing circuitry and mappers, wherein first two bit numbers of the consecutive three-bit numbers are input into the mapper, and a last bit number is input into the zero clearing circuitry, and wherein the last bit number is zeroed and a value of 0 is input into the mapper based on the consecutive three-bit numbers spanning two adjacent first operands a[k] and a[k−1], otherwise, an original value of the last bit number is input into the mapper.

The second processing circuitry may include multiple selection fillers, wherein a selection filler may be configured to process a second operand, and wherein the multiple selection fillers may be configured to synchronously or asynchronously process the second operand.

The multiple selection fillers may be configured to synchronously process the second operand, and the multiplier may be configured to obtain the second operating part B[k] by filling the n second operands b[k] and selecting the second operand b[k] to be processed through the multiple selection fillers.

The multiplier and its computational processing method disclosed in some embodiments may enable switching between multiplication and multiple multiply accumulation operations according to computing requirements, and may save resources for designing multiple multipliers under the condition of meeting the timing requirements.

### BRIEF DESCRIPTION OF THE DRAWINGS

To describe the technical solutions of some embodiments of this disclosure more clearly, the following briefly introduces the accompanying drawings for describing some embodiments. The accompanying drawings in the following description show only some embodiments of the disclosure, and a person of ordinary skill in the art may still derive other drawings from these accompanying drawings without creative efforts. In addition, one of ordinary skill would understand that aspects of some embodiments may be combined together or implemented alone.

FIG. 1 is a structural schematic diagram of the multiplier according to some embodiments;

FIG. 2 is a working schematic diagram of the encoding module in the multiplier according to some embodiments;

FIG. 3 is a working schematic diagram of the second processing module in the multiplier according to some embodiments;

FIG. 4 is flowchart of the computational processing method of the multiplier according to some embodiments;

FIG. 5 is a schematic diagram of converting the second operands b[k] from an unsigned number to a signed number in the multiplier according to some embodiments;

FIG. 6 is a schematic diagram of inserting the first operand a[k] into each bits of the first operating part A in the multiplier according to the second embodiment;

FIG. 7 is a schematic diagram of supplementing 0 when even bits have signed numbers in the first operating part A in the multiplier according to the second embodiment;

FIG. 8 is a schematic diagram of supplementing 0 when odd bits have signed numbers in the first operating part A in the multiplier according to the second embodiment;

FIG. 9 is a schematic diagram of zeroing when existing the consecutive three bit numbers spanning two consecutive first operands a[k] and a[k−1] during the process of selecting the consecutive three bit numbers in the multiplier according to the second embodiment;

FIG. 10 is a flow schematic diagram of the traditional Booth-encoding;

FIG. 11 is a flow schematic diagram of the improved Booth-encoding in the multiplier according to the second embodiment;

FIG. 12 is a schematic diagram of adjusting the second operands b[k] in the multiplier according to the second embodiment;

FIG. 13 is a schematic diagram of the accumulation result output by the accumulation module in the multiplier according to the second embodiment;

FIG. 14 is a schematic diagram of achieving the conversion of the first operands during multiply accumulate operations by using a 12×12 multiplier according to the second embodiment;

FIG. 15 is a schematic diagram of converting the second operands during multiply accumulate operations by using a 12×12 multiplier according to the second embodiment.

### DETAILED DESCRIPTION

To make the objectives, technical solutions, and advantages of the present disclosure clearer, the following further describes the present disclosure in detail with reference to the accompanying drawings. The described embodiments are not to be construed as a limitation to the present disclosure. All other embodiments obtained by a person of ordinary skill in the art without creative efforts shall fall within the protection scope of the present disclosure and the appended claims.

In the following descriptions, related “some embodiments” describe a subset of all possible embodiments. However, it may be understood that the “some embodiments” may be the same subset or different subsets of all the possible embodiments, and may be combined with each other without conflict. As used herein, each of such phrases as “A or B,” “at least one of A and B,” “at least one of A or B,” “A, B, or C,” “at least one of A, B, and C,” and “at least one of A, B, or C,” may comprise all possible combinations of the items enumerated together in a corresponding one of the phrases. For example, the phrase “at least one of A, B, and C” comprises within its scope “only A”, “only B”, “only C”, “A and B”, “B and C”, “A and C” and “all of A, B, and C.”

Some embodiments provide a processor chip comprising a multiplier. A multiplier is a unit in a processor chip that has a large delay and occupies a large area. A multiplier that can multiply two integers with N bits can achieve parallel multiply accumulate operations of multiple signed integers with M bits by modifying a small amount of logic (M and N may satisfy a certain relationship, but there must be M<N), without significantly increasing the delay of the multiplier.

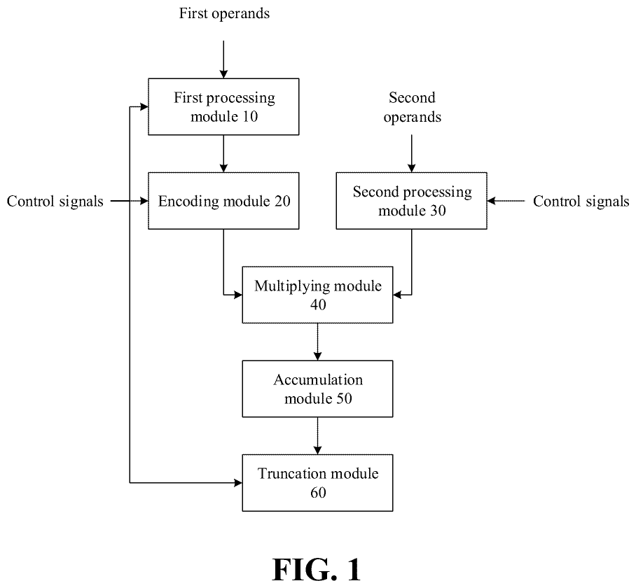

Referring to FIG. 1, the multiplier according to some embodiments comprises a first processing module 10, an encoding module 20, a second processing module 30, a multiplying module 40, an accumulation module 50 and a truncation module 60. The first processing module 10 receives first operands and performs the first processing to obtain the first operating part. Then the first operating part is output to the encoding module 20 for encoding to obtain the intermediate operand. The second processing module 30 receives the second operands and performs the second processing to obtain the second operating part. Then the multiplying module 40 multiplies the intermediate operand and the second operating part correspondingly to obtain the partial products. Then the accumulation module 50 accumulates all partial products to obtain the accumulation result. Finally, the multiplication result is truncated by performing truncating in the accumulation result. During the operation of the above modules, the first processing module 10, the encoding module 20, the second processing module 30 and the truncation module 60 are controlled by controlling signals.

In the multiplier according to some embodiments, the first processing module 10 is used for performing a first processing on n first operands a[k] to obtain the first operating part A which has BIT(A) bits. The encoding module 20 is used for assigning the lowest bit of consecutive three bit numbers spanning two adjacent first operands a[k] and a[k−1] to 0, performing Booth-encoding on the first operating part A to obtain x first encoded data Enc[m]. The second processing module 30 is used for performing a second processing on n second operands b[k] to obtain n corresponding second operating parts B[k], each of which has BIT(B) bits. The multiplying module 40 is used for multiplying the x first encoded data Enc[m] with the corresponding n second operating parts B[k] respectively to obtain x partial products. The accumulation module 50 is used for accumulating the x partial products to obtain the accumulation result. The truncation module 60 is used for truncating the accumulation result to obtain the multiplication result. Wherein, n, k, x, and m are integers, 0≤k<n, 0≤m<x.

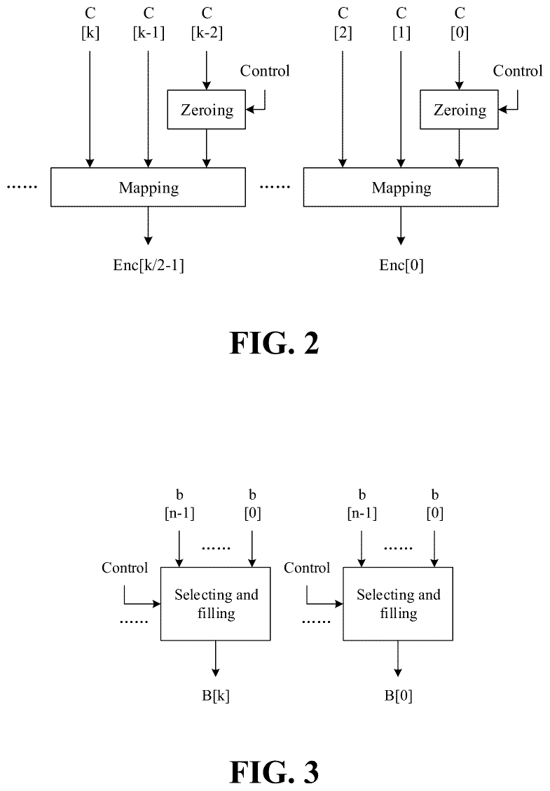

Referring to FIG. 2, in the multiplier according to some embodiments, the encoding module 20 comprises multiple encoding units 21. Each encoding unit 21 has a zero clearing apparatus and a mapper. The first two bit numbers of the consecutive three bit numbers are directly input into the mapper. The last bit number first is input into the zero clearing apparatus. When the consecutive three bit numbers spans two adjacent first operands a[k] and a[k−1], the last bit number is zeroed and the value of 0 is input into the mapper. Otherwise, the original value of the last bit number is input into the mapper. Wherein, the encoding module 20 has improved the traditional Booth-encoding method. FIG. 2 shows the improved control structure of the encoding part, and the encoding processing on the starting bit and the bits labeled (k/2−1) located at the middle. This part of the control structure performs zeroing on the last bit number of the consecutive three bit numbers may be encoded. The control signal controls whether the zero clearing apparatus is to zero the last bit number, and if so, it turns the last bit number to 0. For different operation conditions, the control signal controls the zero clearing apparatus of different encoding units 21 to zeroing the last bit number of the corresponding consecutive three bit numbers.

Referring to FIG. 3, in the multiplier according to some embodiments, the second processing module 30 comprises multiple selection fillers 31. Each selection filler 31 corresponding to processing a second operand. Multiple selection fillers 31 synchronously or asynchronously processing the second operand. Wherein, the second processing carried out by the second processing module 30 on the second operands is to adjust on each second operand b[k] input, comprising: selecting the second operand b[k] with the label k that may be processed from all the second operands input, filling in 0 after the lowest bit and filling in sign bit before the highest bit of the second operand b[k] according to the adjustment rules. These two operations are selecting and filling. When multiple selection fillers 31 synchronously process second operands, first fill each second operand, and then select the second operand b[k] that may be processed through each selection fillers 31 to obtain the second operating part B[k]. When multiple selection fillers 31 asynchronously process second operands, first select the second operand b[k] that may be processed, and then fill the second operand b[k] through the corresponding selection filler 31 to obtain the second operating part B[k]. FIG. 3 shows the encoding processing on the starting bit and the bits labeled k located at the middle. For different operation conditions, the control signal controls the second operand b[k] selected and the filling operation.

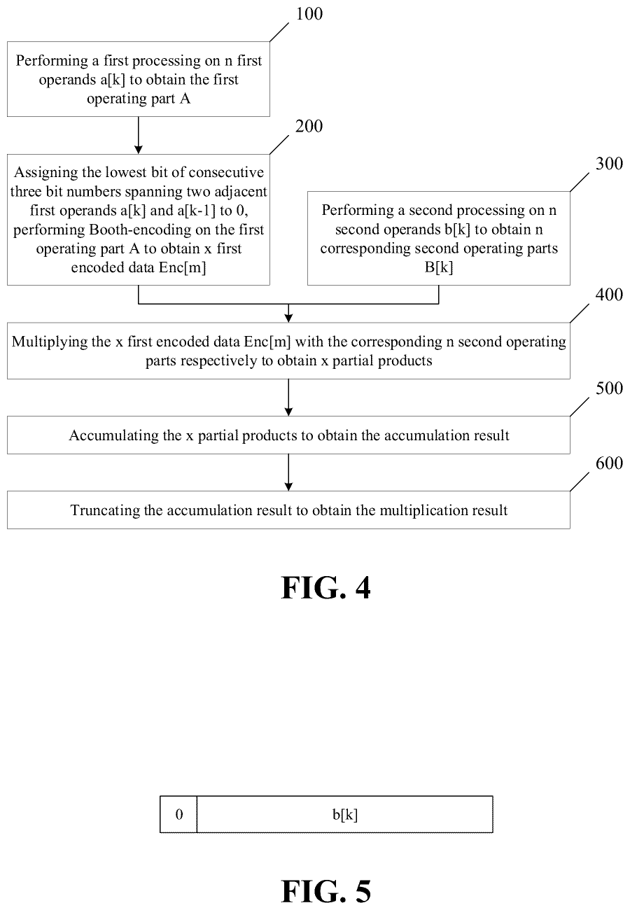

Referring to FIG. 4, the computational processing method, executed by using the multiplier according to some embodiments for performing multiply accumulate operations, comprises:
100: performing a first processing on n first operands a[k] to obtain the first operating part A which has BIT(A) bits;
200: assigning the lowest bit of consecutive three bit numbers spanning two adjacent first operands a[k] and a[k−1] to 0, performing Booth-encoding on the first operating part A to obtain x first encoded data Enc[m];
300: performing a second processing on n second operands b[k] to obtain n corresponding second operating parts B[k], each of which has BIT(B) bits;
400: multiplying the x first encoded data Enc[m] with the corresponding n second operating parts respectively to obtain x partial products;
500: accumulating the x partial products to obtain the accumulation result;
600: truncating the accumulation result to obtain the multiplication result;
where, n, k, x, and m are integers, 0≤k<n, 0≤m<x.

In this computational processing method, 100 comprises:
101: obtaining n first operands a[k] and setting the first operating part A, where each first operand a[k] has BIT(a[k]) bits and is a signed number, the first operating part A has BIT(A) bits, BIT(a[k]) is even, and satisfying Σ₀ⁿ⁻¹BIT(a[k])≤BIT(A);
102: arranging the n first operands a[k] in descending order from large to small according to the value of the label k, the first operand a[k] in the previous position is adjacent to the first operand a[k−1] in the latter position;
103: arranging each first operand a[k] in descending order from the highest bit a[k][BIT(a[k])−1] to the lowest bit a[k][0];
104: starting from the lowest bit in the BIT(A) bits of the first operating part A, inserting the first operand a[k] corresponding to the label k into each bit BIT(A[k]) of the BIT(A) bits in sequence;
105: determining the magnitude relationship between BIT(A) and the sum of bits of all first operands Σ₀ⁿ⁻¹BIT(a[k]); if satisfying Σ₀ⁿ⁻¹BIT(a[k])<BIT(A), executing 106; if satisfying Σ₀ⁿ⁻¹BIT(a[k])=BIT(A), executing 107;
106: then filling the highest bit a[n−1][BIT(a[n−1])−1] of the first operand a[n−1] as the sign bit before the highest bit a[n−1] of all first operands;
107: outputting the first operating part A.

In this computational processing method, 200 comprises:
201: determining the parity of BIT(A); if BIT(A) is odd, executing 202; if BIT(A) is even, executing 203;
202: supplementing the highest bit a[n−1][BIT(a[n−1])−1] of the first operand a[n−1] as the sign bit before the highest bit of the first operating part A;
203: supplementing 0 after the lowest bit of the first operating part A to obtain the intermediate operand C which has BIT(C) bits;
204: from the BIT(C) bits of the intermediate operand C, continuously selecting three bits every two bits interval as the consecutive three bit numbers to be encoded;
205: determining whether each consecutive three bit numbers spans two consecutive first operands a[k] and a[k−1]; if spanning, executing 206; if not spanning, executing 207;
206: assign the lowest bit a[k−1][BIT(a[k])−1] in the consecutive three bit numbers to 0;
207: referring to the Booth-encoding truth-value table, performing truth-value mapping on all consecutive three bit numbers to obtain x first encoded data Enc[m];
wherein, when BIT(A) is odd, x=(BIT(A)+1)/2; when BIT(A) is even, x=BIT(A)/2.

In this computational processing method, 300 comprises:
301: obtaining n second operands b[k] and setting the second operating part B[k] corresponding to each second operand b[k], wherein, each second operand bb[k] has BIT(b[k]) bits, each second operating part B[k] has BIT(B) bits, when k=n−1, BIT(b[k])≤BIT(B), when 0≤k≤n−2,

$$BIT ( b [ k ] ) + {\sum }_{i = k}^{n - 2} BIT ( a [ i ] ) ⩽ BIT ( B ) ;$$

302: determining whether the second operand b[k] is a signed number; if yes, executing 303; if no, executing 304;
303: supplementing 0 as the sign bit before the highest bit of the second operand b[k], the number of BIT(B) bits in the second operating part B[k] correspondingly adding 1;
304: determining the magnitude of k; if 0≤k≤n−2, executing 305; if k=n−1, executing 306;
305: supplementing Σᵢ₌ₖⁿ⁻²BIT(a[i]) 0 s after the lowest bit of the second operand b[k];
306: supplementing all bits before the highest bit of the second operand b[k] with the sign bit b[k][BIT(b[k])−1];
307: outputting all n second operating parts B[k].

In this computational processing method, 400 comprises:
401: querying the consecutive three bit numbers corresponding to each first encoded data Enc[m] before performing truth-value mapping;
402: confirming the first operand a[k] corresponding to the consecutive three bit numbers according to the value of the label k corresponding to each bit in the consecutive three bit numbers;
403: determining whether the consecutive three bit numbers spans two consecutive first operands a[k] and a[k−1]; if spanning, executing 404; if not spanning, executing 405;
404: specifying that the consecutive three bit numbers correspond to the first operand a[k];
405: confirming the second operating part B[k] corresponding to each first encoded data Enc[m] according to the first operand a[k] corresponding to the consecutive three bit numbers;
406; multiplying each first encoded data Enc[m] with its corresponding second operating part B[k] respectively to obtain x partial products.

In this computational processing method, 600 comprises:
601: confirming that the accumulation result has BIT(D) bits and the maximum number of bits BIT(E) for the multiplication result according to the BIT(A) and the BIT(B);
602: starting from the lowest bit in BIT(D) bits of the accumulation result, discarding Σᵢ₌₀ⁿ⁻²BIT(a[i]) bits;
603: starting from the (Σᵢ₌₀ⁿ⁻²BIT(a[i])+1)-th bit in BIT(D) bits of the accumulation result, truncating the number of bits with the maximum number of bits BIT(E) from the low bit to the high bit as the multiplication result;
604: outputting the multiplication result.

The multiplier according to some embodiments is an A×B multiplier, which achieves multiple multiplication states (comprising simple A×B and multiply accumulate operations) by executing the computational processing method as described above through multiple modules. When using this multiplier to achieve multiply accumulate operations, there are certain requirements for the multiply accumulate operations that can be achieved. Assuming that the multiply accumulate operations that may be achieved is presented by the following formula:

$$a [ 0 ] \times b [ 0 ] + a [ 1 ] \times b [ 1 ] + … + a [ n - 1 ] \times b [ n - 1 ] . \qquad formula ( 1 )$$

This formula (1) represents that there are a total of n multiplications, and then the results of each multiplication are added up. The labels of each multiplication are n−1, n−2 . . . 2, 1, 0. The multiplication labeled k represents as a[k]×b[k].

Assuming that the number of bits in the first operating part A is BIT(A), the number of bits in the second operating part B (comprising all B[k]) is BIT(B), and similarly, the number of bits in a[x] is BIT(a[x]). For the above A, B, a[0], b[0] . . . a[n−1], b[n−1], in the above computational processing method, in operation 101, the bits of all the first operands may be even, for example, BIT(a[0]) . . . BIT(a[n−1]) are even. The relationship between BIT(A) and each BIT(a[k]) satisfy:

$${\sum }_{0}^{n - 1} BIT ( a [ k ] ) = BIT ( a [ 0 ] ) + BIT ( a [ 1 ] ) + … + BIT ( a [ n - 1 ] ) ⩽ BIT ( A ) . \qquad formular ( 2 )$$

In the above computational processing method, in operation 301, in all second operands b[k], when the label k satisfies 0≤k≤n−2, b[k] satisfies:

$$BIT ( b [ k ] ) + {\sum }_{i = k}^{n - 2} BIT ( a [ i ] ) ⩽ BIT ( B ) ; \qquad formula ( 3 )$$

when k=n−1, it satisfies: BIT(b[k])≤BIT(B). For the symbols of the first operands and the second operands, in operation 101, all first operands a[k] may be signed numbers, while for the second operands b[k], they may be signed numbers during the second processing on them. Therefore, operation 302 performs a sign determination on the second operands b[k]. If there exists that the second operand b[k] is an unsigned number, one bit 0 may be expanded before the second operand b[k] to convert it to a signed number, as shown in FIG. 5. Accordingly, the number of bits in the second operating part B[K] corresponding to this second operand b[k] may be expanded by one bit.

For example, in the case where the number of bits in the first operating part A is BIT(A)=24 and the number of bits in the second operating part B is BIT(B)=24, the multiply accumulate operations that the A×B multiplier according to some embodiments can achieve is as the following formula: 8bit×8 bit+8bit×8 bit+8bit×8 bit, formula (4), where n bit represents that there are n bits binary numbers. In formula (4), for the part of the first operands a[k], the number of bits of a[0], [1] and a[2] satisfies with BIT(A): 8+8+8≤24, while for the part of the second operands b[k], the number of bits of b[0], b[1] and b[2] satisfies with BIT(B): 8≤24, 8+8≤24, 8+8+8≤24. It can be observed that there is a margin in the conditions set above. In fact, for the case of BIT(A)=24 and BIT(B)=24, the multiply accumulate operations that can be achieved can also be as the following formula: 8bit×24 bit+8bit×16 bit+8bit×8 bit, formula (5). In formula (5), for the part of the first operands a[k], the number of bits of a[0], [1] and a[2] satisfies with BIT(A): 8+8+8≤24, while for the part of the second operands b[k], the number of bits of b[0], b[1] and b[2] satisfies with BIT(B): 24≤24, 16+8≤24, 8+8+8≤24. If the part of the second operands b[k] is unsigned, it may be converted to signed first, and in this case, BIT(B)=25 may be set.

The multiplier, according to some embodiments, may implement operations 100 to 600 above. For the first operands a[k], a[n−1] . . . a[0] are packaged into an equivalent input of the first operation part A through the first processing module 10, and then enters the encoding module 20 to encode the first operation part A. The encoding method uses Booth-encoding, which has been improved to a certain extent compared to the traditional Booth-encoding. For the second operands b[k] which are adjusted by the second processing module 30, b[n−1] . . . b[0] are respectively mapped to the inputs of each B[k] in the second operating part B. The second operating part B is not just a single value, but each B[k] in n second operating part B corresponding to the first operands b[k]. Then, by inputting control signals to the first processing module 10, the encoding module 20, the second processing module 30, and the truncation module 60 respectively, multiple operations are achieved by using the multiplier according to some embodiments. When the operations processed change, the control signals can enable to change the processing method accordingly.

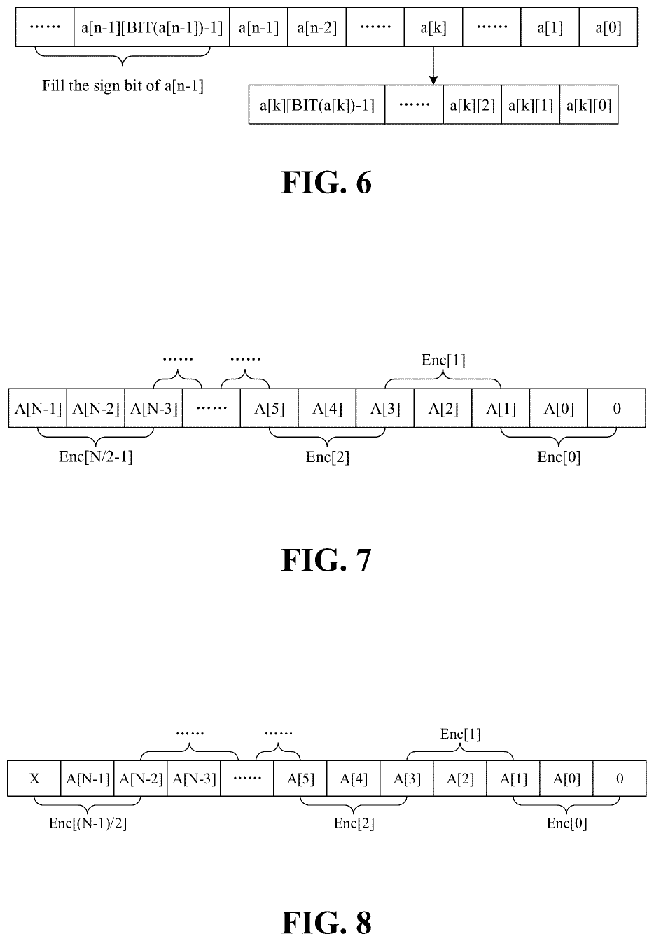

In some embodiments, the procedure, that the first processing module 10 continuously concatenates multiple first operands a[k] to form the first operation part A, is shown in FIG. 6. In FIG. 6, the arrow below a[k] represents the details of packaging and inserting the multiplicator a[k] labeled k into A, which is inserted in order from the highest bit a[k][BIT(a[k])−1] to the lowest bit a[k]1[0]. If the number of bits BIT(A) of the first operating part A is greater than the sum of the number of bits BIT(a[k]) of all the first operands a[k], then the sign bit of the first operand a[n−1] located at the highest bit, for example, the highest bit a[n−1][BIT(a[n−1])−1] of a[n−1], is filled in the highest bit of the first operation part A. After filling, the filled first operating part A is output to the encoding module 20.

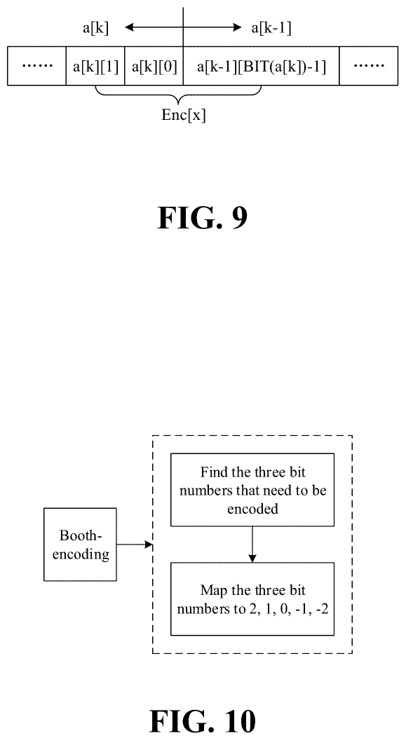

In some embodiments, the encoding module 20 assigns the lowest bit of the consecutive three bit numbers spanning two adjacent first operands in the first operating part A, and achieves the procedure of Booth-encoding on the first operating part A by executing 201 to 207. For the first operating part A, the number of bits of it is filled in based on parity. Since the first operating part A is a signed number, the case of unsigned numbers is not considered. As shown in FIG. 7, when BIT (A) is even, a 0 is supplemented at the end of the first operating part A. The first operating part A that has been supplemented is called the intermediate operand C. After that, the consecutive three bit numbers of the intermediate operand C are encoded every two bits interval. As shown in FIG. 8, when BIT (A) is odd, it may supplement a 0 at the end of the first operating part A, it may supplement a sign bit at the head of the first operating part A. Since the first operating part A is a signed number, this sign bit is the highest bit a[n−1][BIT(a[n−1])−1] of the first operand a[n−1] which is located at the highest bit in the first operation part A. The first operating part A that has been supplemented A is called the intermediate operand C. After that, the consecutive three bit numbers of the intermediate operand C are encoded every two bits interval. Since the first operand a[k] is always even, when selecting the consecutive three bit numbers, for every two consecutive first operands a[k] and a[k−1], the consecutive three bit numbers that spans both will definitely be selected. As shown in FIG. 9, for such consecutive three bit numbers, the lowest bit at the end of them is selected to be 0, that is, the consecutive three bit numbers in the figure changes to {a[k][1], a[k][0], 0}, and then Booth-encoding is performed. In the procedure of performing Booth-encoding on the first operating part A, a truth value mapping on the intermediate operand C that have been filled after bits supplementation is performed according to Table 1 (Truth Value Mapping Table) to obtain the first encoded data after Booth-encoding. This first encoded data is defined as Enc[m] with a quantity of x, when BIT (A) is odd, x=(BIT (A)+1)/2; when BIT (A) is even, x=BIT (A)/2.

TABLE 1

| {C[x], C[x-1], C[x-2]} | Enc[x/2-1] |
|---|---|
| 000 | 0 |
| 001 | 1 |
| 010 | 1 |
| 011 | 2 |
| 100 | −2 |
| 101 | −1 |
| 110 | −1 |
| 111 | 0 |

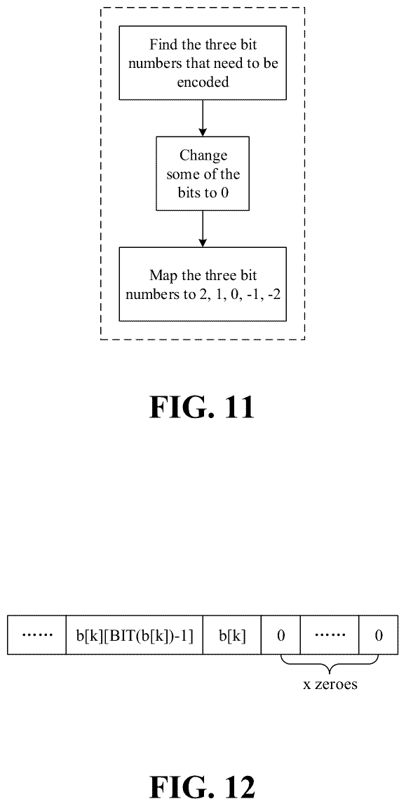

Compared to the traditional Booth-encoding procedure shown in FIG. 10, some embodiments, as shown in FIG. 11, assign the value of the lowest bit a[k−1][BIT(a[k])−1] of the consecutive three bit numbers to 0 before using the multiplier to perform Booth-encoding on the consecutive three bit numbers that spans two consecutive first operands a[k] and a[k−1], which can reduce the computational complexity of subsequent multiplying operations and save resources consumed by the multiplier.

For example, if the number of bits BIT (A) in the first operating part A is 9, and the first operand is {a[2], a[1], a[0]}, where a[2]=10, a[1]=10, and a[0]=1100, then the number of bits in each first operand is BIT(a[2])=2, BIT(a[1])=2, and BIT(a[0])=4. Perform multiplication operation of each first operand and each second operand to compute a[2]×b[2]+a[1]×b[1]+a[0]×b[0]. Firstly, package and spell the three first operands into the input first operating part A, place the four bits of a[0] in the low bit, then place the two bits of a[1], and then place the two bits of a[2] to obtain 10101100. Since BIT(A)>BIT(a[0])+BIT(a[1])+BIT(a[2]), the highest bit 1 of a[2] is used to fill the one bit before the highest bit of the first operating part A to obtain 110101100 (the underlined number is an additional addition). Then, by the supplementation through determining the parity of the first operating part A, it is known that when the first operating part A is odd, 0 is supplemented after the lowest bit of the first operating part A, and the highest bit 1 of a[2] is supplemented before the highest bit of the first operating part A as a sign bit, thus completing the intermediate operand C, to obtain 11101011000 (the underlined number is an additional addition). Further refer to the above Table 1 for true value mapping to obtain the first encoded data. The three values connected by an underline in the following data are consecutive three bit numbers, represented by an underline in the first encoded data, that is, Enc[0]=0(11101011000), Enc[1]=−1(11101011000), Enc[2]=−2(11101011000, in which 101 spans a[1] and a[0], and is mapped after becoming 100), Enc[3]=−2(11101011000, in which 101 spans a[2] and a[1], and is mapped after becoming 100), Enc[4]=0(11101011000).

In some embodiments, the second processing module 30 adjusts multiple second operands b[k] to obtain the same number of second operation parts B[k]. Compared to the case in traditional multipliers that the second operating part B used as a multiplicator is the same for each bit of the first encoded data Enc, that is, when performing multiplication operations, Enc[N−1]×B, Enc[N−2]×B . . . Enc[1]×B, Enc[0]×B are computed, and for all the first encoded data Enc, the same second operation part B are multiplied by it, to achieve multiply accumulate operations in some embodiments, different second operating parts B [k] may be multiplied by the first encoded data Enc[m]. Through the second processing module 30, execute operations 301 to 307 to adjust each second operand b[k], with slightly different adjustment methods for different labels k. If the label k is from 0 to n−2, first supplement 0 after the lowest bit of the second operand b[k]. The number of 0 s supplemented varies depending on the label of k, which is

$${\sum }_{i = k}^{n - 2} BIT ( a [ i ] ) . \qquad formula ( 6 )$$

If the label k=n−1, 0 may not be supplemented after the lowest bit of the second operand b[n−1]. Then no matter what the label k is, always supplement the value of the highest bit b[k][BIT(b[k])−1] as the sign bit before the highest bit b[k][BIT(b[k])−1] of the second operand b[k], until all bits of the second operating part B[k] were filled, as shown in FIG. 12.

For example, if the BIT (A) of the first operating part A is 9 bits, and the first operand is {a[2], a[1], a[0]}, where a[2]=10, a[1]=10, a[0]=1100, then the number of bits in each first operand is BIT(a[2])=2, BIT(a[1])=2, and BIT(a[0])=4. If the BIT(B) of each B[k] in the second operating part B is 9 bits, and the second operand is {b[2], b[1], b[0]}, where b[2]=10, b[1]=11, b[0]=010, then the number of bits in each second operand is BIT(b[2])=2, BIT(b[1])=2, and BIT(b[0])=3. Then perform multiplication operations on each first operand and each second operand, computing a[2]×b[2]+a[1]×b[1]+a[0]×b[0]. According to the previous computation, the first encoded data Enc[m] obtained after encoding the first operating part A are {Enc(4), Enc(3), Enc(2), Enc(1), Enc(0)}, respectively, wherein Enc[0]˜Enc[1] belong to a[0], Enc[2] belongs to a[1], and Enc[3]˜Enc[4] belong to a[2]. For each second operand, the adjustment method described above is used to process it. First, determine the number of 0 s to be supplemented at the end according to formula (6), and then fill the head with the sign bits based on the remaining bits. For b[0], since BIT(a[1])+BIT(a[0])=6, six 0 s are added at the end of b[0]. Since the BIT(B) of B[0] is 9 bits, there are no remaining bits left, so sign bits at the head of b[0] may not be supplemented. The processing result is the second operating part B[0]=010000000 (the underlined number is an additional addition). For b[1], since BIT(a[1])=2, two 0 s are added at the end of b[0]. Since the BIT(B) of B[1] is 9 bits and the remaining 5 bits, five sign bits 1 are supplemented at the head of b[1]. The processing result is the second operating part B[1]=111111100 (the underlined number is an additional addition). For b[2], since k=n−1 is satisfied, 0 is not filled at the end of b[2]. Since the BIT(B) of B[2] is 9 bits, there are 7 remaining bits. The processing result is 111111110 (red indicates additional addition). Finally, the B[k]{B[2], B[1], B[0]}={111111110, 111111100, 010000000} of the second operating part B are output to the multiplying module 40.

In some embodiments, the multiplying module 40 executes operations 401 to 406, performing the multiplication operations on each first encoded data Enc[m] and the corresponding second operating part B[k] to obtain x partial products. Each Enc [m] corresponds to which second operating part B[k] is multiplied, depending on which first operating part a[k] contains the consecutive three bit numbers used for mapping of Enc[m]. For example, in FIG. 11, consecutive three bit numbers is mapped to Enc[m], where two bits of the consecutive three bit numbers are located in a[k], and the remaining bit is 0. Therefore, it is considered that the consecutive three bit numbers belongs to a[k], and what multiplies with Enc[m] is the second operating part B[k] adjusted by the second operand b[k]. For labels k and m, if Enc[k] and Enc[m] are mapped from consecutive three bit numbers in a[k] belonging to the same label k, there may be a case where B[k]=B[m]. The value of Enc[m] is one of {−2, −1, 0, 1, 2}, and the multiplying module 40 can use the same structure as the general base 4 high-speed multiplier. Taking the example in the previous text, Enc [3]˜Enc [4] correspond to B[2], Enc[2] corresponds to B[1], and Enc [0]˜Enc[1] correspond to B[0]. The multiplication operations between each first operand and each second operand are converted into the multiplication operations between each first encoded data obtained by encoding each first operand and each second operating part obtained by adjusting each second operand, that is to multiply the five first encoded data {Enc(4), Enc(3), Enc(2), Enc(1), Enc(0)} with the corresponding second operating part {B[2], B[1], B[0]}, for example, Enc[0]×000000000, Enc[1]×010000000, Enc[2]×111111100, Enc[3]×111111110, Enc[4]×111111110, and finally obtain 5 partial products.

In some embodiments, the accumulation module 50 accumulates x partial products obtained from the above multiplication operations and outputs the accumulation result to the truncation module 60. The accumulation module 50 can also use the same structure as the general base 4 high-speed multiplier.

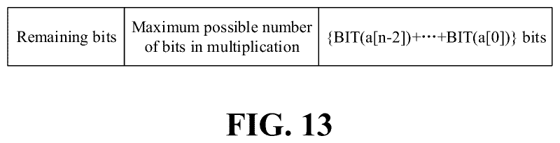

In some embodiments, the truncation module 60 executes operations 601 to 604 to truncate the desired multiplication result, which is obtained by performing operations on the first operands and the second through the multiplier of this embodiment operands, from bits of the accumulation result. As shown in FIG. 13, the accumulation result has BIT(D) bits, comprising three parts: the excess bits located in low bits with the number of Σᵢ₌₀ⁿ⁻²BIT(a[i])+1, the maximum number of bits of the multiplication result located in the middle with the number of BIT (E), and the remaining bits in high bits. Among them, the excess bits located in low bits are all 0 and considered invalid bits in the accumulation result, and the remaining bits located in high bits are invalid bits that exceed the multiplication result. Therefore, the truncation module 60 truncates the middle part, and may truncate a number of BIT(E) bits starting from the Σᵢ₌₀ⁿ⁻²BIT(a[i])+1-th bit. The maximum number of bits BIT(E) is the number of bits of the maximum value that may occur in the results computed according to a[0]×b[0]+a[1]×b[1]+ . . . +a[n−1]×b[n−1]. It is assumed that all a[k] and b[k] are the maximum values that can be taken by itself, and then through computing to see how many bits the result is, then how many bits the BIT(E) is. The maximum number of bits BIT(E) can be estimated by an estimation method. For all labels k, compute the values of BIT(a[k])+BIT(b[k]) respectively, select the maximum value from these values, and then multiply the maximum value by ceil(log₂n), to obtain the maximum number of bits BIT(E), where log₂ is to take the logarithm of 2 and ceil is round up. For example, if n is 4 and the maximum value of BIT(a[k])+BIT(b[k]) is 4, then the maximum number of bits BIT(E) is 4×ceil(log₂4)=8, which is 8 bits. For example, the BIT(A) of the first operating part A is 9 bits, and the first operand is a[2]=10, a[1]=10, a[0]=1100. The BIT(B) of each B[k] of the second operating part B is 9 bits, and the second operand b[2]=10, b[1]=11, b[0]=010. Compute a[2]×b[2]+a[1]×b[1]+a[0]×b[0]. It can be seen that the BIT(D) of the accumulation result is a total of 18 bits, labeled as 17, 16, 15 . . . 1, 0. Since BIT(a[1])+BIT(a[0])=6, we discard the six 0-bits located in low bits of 5, 4, 3, 2, 1, 0 and start taking from the 6th bit. Since the maximum number of bits BIT(E) in the multiplication result is maximum 8 bits, we start taking 8 bits from the 6th bit of the accumulation result, that is to truncate the 8 bits of 13, 12, 11, 10, 9, 8, 7, 6. Finally, the multiplication result that is truncated from the accumulation result is output. The control structure of the truncation module 60 is also a selector, whose input is the accumulation result output by the accumulation module 50, which selects the maximum number of bits BIT(E) of different bits according to different operation scenarios.

According to some embodiments, each module, unit, or circuit may exist respectively or be combined into one or more modules, units, or circuits. Some modules, units, or circuits may be further split into multiple smaller function subunits or circuits, thereby implementing the same operations without affecting the technical effects of some embodiments. The modules or units are divided based on logical functions. In actual applications, a function of one module or unit may be realized by multiple modules, units, or circuits, or functions of multiple modules, units, or circuits may be realized by one module, unit, or circuit. In some embodiments, the multiplier or processor chip may further include other modules, units, or circuits. In actual applications, these functions may also be realized cooperatively by the other modules, units, or circuits, and may be realized cooperatively by multiple modules, units, or circuits.

A person skilled in the art would understand that these “modules,” “units,” or “circuits” could be implemented by hardware logic, a processor or processors executing computer software code, or a combination of both. The “modules,” “units,” or “circuits” may also be implemented in software stored in a memory of a computer or a non-transitory computer-readable medium, where the instructions of each unit are executable by a processor to thereby cause the processor to perform the respective operations of the corresponding module or unit.

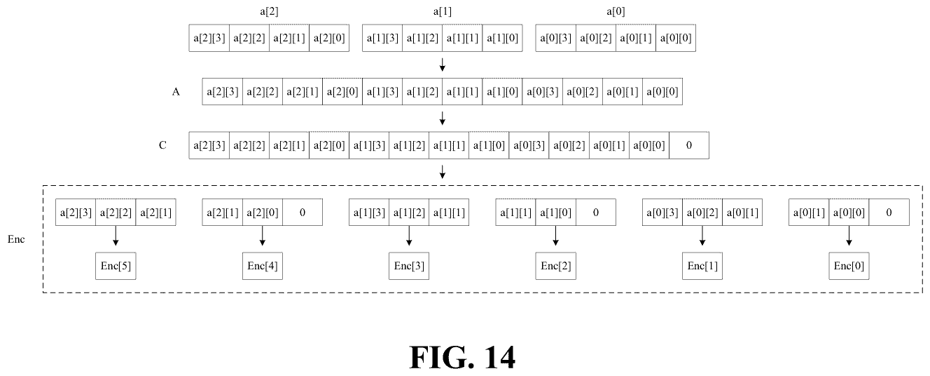

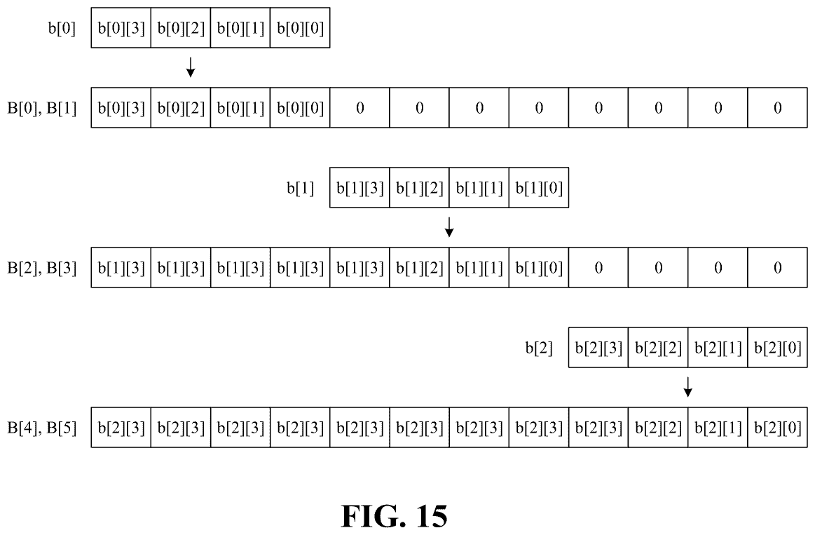

The examples shown in FIG. 14 and FIG. 15 are the first processing of the first operating part A and the second processing of the second operating part B by a 12×12 multiplier.

It can be seen that the first operands {a[2], a[1], a[0]} are all signed numbers with 4 bits. The first operand a[2] is {a[2][3], a[2][2], a[2][1], a[2]1[1], a[2][0]}, the first operand a[1] is {a[1][3], a[1]1[2], a[1][1], a[1][0]}, and the first operand a[0] is {a[0][3], a[0][2], a[0][1], a[0][0]}. First, concatenate the first operands {a[2], a[1], a[0]} in the first row of FIG. 13 to obtain the first operating part A in the second row as {a[2][3], a[2][2], a[2][1], a[2][0], a[1][3], a[1][2], a[1][1], a[1][0], a[0][3], a[0][2], a[0][1], a[0][0]}. Further perform improved Booth-encoding on the first operating part A to obtain the first encoded data C in the third row as {a[2][3], a[2][2], a[2][1], a[2][0], a[1][3], a[1][2], a[1][1], a[1][0], a[0][3], a[0][2], a[0][1], a[0][0], 0}, and perform a true value mapping on the first encoded data C. Since the consecutive three bit numbers {a[1][1], a[1][0], a[0][3]} spans a[1] and a[0], {a[2][1], a[2][0], a[1][3]} spans a[2] and a[1], so assign the lowest bit of the consecutive three bit numbers {a[1][1], a[1][0], a[0][3]} and {a[2][1], a[2][0], a[1][3]} to 0 to obtain the six first encoded data {Enc(5), Enc(4), Enc(3), Enc(2), Enc(1), Enc(0)} in the fourth row, as shown in the dashed box, Enc(5) corresponds to a[2], Enc(4) corresponds to a[2], Enc(3) corresponds to a[1], Enc(2) corresponds to a[1], Enc(1) corresponds to a[0], and Enc(0) corresponds to a[0].

The second operands {b[2], b[1], and b[0]} are also all signed numbers with 4 bits, so additional bits may not be added to the BIT(B) of the second operating part B. The second operand b[2] is {b[2][3], b[2][2], b[2][1], b[2][0]}, the second operand b[1] is {b[1][3], b[1][2], b[1][0]}, and the second operand b[0] is {b[0][3], b[0][2], b[0][1], b[0][0]}. Compute the number of 0 s that are to be supplemented at the end of the lowest bit in the second operands b[0] and b[1], respectively. According to formula (6), it can be seen that eight 0 s are to be supplemented at the end of b[0] and four 0 s are to be supplemented at the end of b[1]. Then fill the remaining bits before the highest bit of the second operands {b[2], b[1], b[0]} with the sign bits. After supplementation, there are no remaining bits before the highest bit of b[0], so the sign bit may not be supplemented, the second operating part B[0] is obtained as {b[0][3], b[0][2], b[0][1], b[0][0], 0, 0, 0, 0, 0, 0, 0, 0}. There are 4 remaining bits in b[1], so 4 signed bits may be supplemented, for example, b[1]1[3], to obtain the second operating part B[1] as {b[1][3], b[1][3], b[1][3], b[1][3], b[1][3], b[1][2], b[1][1], bi[1][0], 0, 0, 0, 0}. There are 8 remaining bits in b[2], so 8 signed bits may be supplemented, for example, b[2][3], to obtain the second operating part B[2] as {b[2][3], b[2][3], b[2][3], b[2][3], b[2][3], b[2][3], b[2][3], b[2][3], b[2][3], b[2][2], b[2][1], b[2][0]}.

According to the above examples, the first encoding data Enc[m] can be associated with the second operating part B[k] based on the correspondence between the labels k and m, and further the multiply accumulate operation of 4×4+4×4+4×4 can be achieved by using a 12×12 multiplier.

The multiplier and its computational processing method disclosed in some embodiments enable to freely switch between simple multiplication and multiple multiply accumulation operations according to computing requirements, and to save resources for designing multiple multipliers under the condition of meeting the timing requirements.

The foregoing embodiments are used for describing, instead of limiting the technical solutions of the disclosure. A person of ordinary skill in the art shall understand that although the disclosure has been described in detail with reference to the foregoing embodiments, modifications can be made to the technical solutions described in the foregoing embodiments, or equivalent replacements can be made to some technical features in the technical solutions, provided that such modifications or replacements do not cause the essence of corresponding technical solutions to depart from the spirit and scope of the technical solutions of the embodiments of the disclosure and the appended claims.

What is claimed is:

1. A computational processing method of multiplier, performed by a processor chip, comprising:
obtaining, based on n first operands a[k], a first operating part A comprising BIT(A) bits;
obtaining x first encoded data Enc[m] by assigning a lowest bit of consecutive three-bit numbers spanning two adjacent first operands a[k] and a[k−1] to 0, and performing Booth-encoding on the first operating part A;
obtaining, based on n second operands b[k], n corresponding second operating parts B[k], each of which has BIT(B) bits;
obtaining x partial products based on multiplying the x first encoded data Enc[m] with the n corresponding second operating parts;
obtaining an accumulation result based on accumulating the x partial products;
obtaining a multiplication result based on truncating the accumulation result;
wherein, n, k, x, and m are integers, and
wherein 0≤k<n, and 0≤m<x.

2. The computational processing method according to claim 1, wherein the obtaining the first operating part A comprises:
obtaining the n first operands a[k] and setting the first operating part A, wherein:
the n first operands a[k] each have BIT(a[k]) bits and are signed numbers,
the first operating part A has BIT(A) bits, and
BIT(a[k]) is even and satisfies Σ₀ⁿ⁻¹BIT(a[k])≤BIT(A);
arranging the n first operands a[k] in descending order from largest to smallest according to a value of label k, wherein a first operand a[k] in a first position is adjacent to a first operand a[k−1] in a second position;
arranging the n first operands a[k] in descending order from highest bit a[k][BIT(a[k])−1] to lowest bit a[k][0];
starting from a lowest bit in the BIT(A) bits of the first operating part A, inserting the first operand a[k] corresponding to the label k into each bit BIT(A[k]) of the BIT(A) bits in sequence;
determining a magnitude relationship between BIT(A) and a sum of bits of the n first operands Σ₀ⁿ⁻¹BIT(a[k]);
filling, based on Σ₀ⁿ⁻¹BIT(a[k]) being less than BIT(A), highest bit a[n−1][BIT(a[n−1])−1] of first operand a[n−1] as a sign bit before a highest bit a[n−1] of the n first operands; and
outputting the first operating part A based on Σ₀ⁿ⁻¹BIT(a[k]) being equal to BIT(A).

3. The computational processing method according to claim 1, wherein the obtaining the x first encoded data Enc[m] comprises:
determining parity of BIT(A);
supplementing, based on BIT(A) being odd, highest bit a[n−1][BIT(a[n−1])−1] of the first operand a[n−1] as a sign bit before a highest bit of the first operating part A;
supplementing, based on BIT(A) being even, 0 after a lowest bit of the first operating part A to obtain intermediate operand C which has BIT(C) bits;
from the BIT(C) bits of the intermediate operand C, continuously selecting three bits every two bits interval as the consecutive three-bit numbers to be encoded;
determining whether the consecutive three-bit numbers spans two consecutive first operands a[k] and a[k−1];
assign, based on the consecutive three-bit numbers spanning the two consecutive first operands a[k] and a[k−1], a lowest bit a[k−1][BIT(a[k])−1] in the consecutive three-bit numbers to 0; and
obtaining, based on the consecutive three-bit numbers not spanning the two consecutive first operands a[k] and a[k−1], the x first encoded data Enc[m] based on:
referring to a Booth-encoding truth-value table, and
performing truth-value mapping on the consecutive three-bit numbers,
wherein, x=(BIT(A)+1)/2 based on BIT(A) being odd, and x=BIT(A)/2 based on BIT(A) being even.

4. The computational processing method according to claim 1, wherein the obtaining the n corresponding second operating parts B[k] comprises:
obtaining the n second operands b[k] and setting the second operating part B[k] corresponding to each second operand b[k], wherein, the second operands b[k] each have BIT(b[k]) bits, and the second operating parts B[k] each have BIT(B) bits, and wherein BIT(b[k])≤BIT(B) when k=n−1, and BIT(b[k])+Σᵢ₌ₖⁿ⁻²BIT(a[i])≤BIT(B) when 0≤k≤n−2;
determining whether the second operand b[k] is a signed number;
supplementing, based on the second operand b[k] being a signed number, 0 as a sign bit before a highest bit of the second operand b[k], and correspondingly adding 1 to the number of BIT(B) bits in the second operating part B[k];
determining, based on the second operand b[k] not being a signed number, a magnitude of k;
supplementing, based on 0≤k≤n−2, Σᵢ₌ₖⁿ⁻²BIT(a[i]) 0 s after a lowest bit of the second operand b[k];
supplementing, based on k=n−1, all bits before the highest bit of the second operand b[k] with sign bit b[k][BIT(b[k])−1]; and
outputting n second operating parts B[k].

5. The computational processing method according to claim 1, wherein the obtaining the x partial products comprises:
querying the consecutive three-bit numbers corresponding to the x first encoded data Enc[m] before performing truth-value mapping;
confirming the first operand a[k] corresponding to the consecutive three-bit numbers according to a value of the label k corresponding to each bit in the consecutive three-bit numbers;
determining whether the consecutive three-bit numbers spans two consecutive first operands a[k] and a[k−1];
specifying, based on the consecutive three-bit numbers spanning two consecutive first operands a[k] and a[k−1], that the consecutive three-bit numbers correspond to the first operand a[k];
confirming, based on the consecutive three-bit numbers not spanning two consecutive first operands a[k] and a[k−1], the n second operating parts B[k] corresponding to the x first encoded data Enc[m] according to the first operands a[k] corresponding to the consecutive three-bit numbers; and
multiplying the x first encoded data Enc [m] with the n second operating parts B[k] to obtain the x partial products.

6. The computational processing method according to claim 1, wherein the obtaining the multiplication result comprises:
confirming the accumulation result has BIT(D) bits and a maximum number of bits BIT(E) for the multiplication result according to the BIT(A) and the BIT(B);
starting from the lowest bit in BIT(D) bits of the accumulation result, and discarding Σᵢ₌₀ⁿ⁻²BIT(a[i]) bits;
starting from the (Σᵢ₌₀ⁿ⁻²BIT(a[i])+1)-th bit in BIT(D) bits of the accumulation result, truncating a number of bits with the maximum number of bits BIT(E) from a low bit to a high bit as the multiplication result; and
outputting the multiplication result.

7. A multiplier of a processor chip, comprising:
first processing circuitry configured to obtain, based on n first operands a[k], a first operating part A comprising BIT(A) bits;
encoding circuitry configured to obtain x first encoded data Enc[m] by assigning a lowest bit of consecutive three-bit numbers spanning two adjacent first operands a[k] and a[k−1] to 0, and performing Booth-encoding on the first operating part A;
second processing circuitry obtain, based on n second operands b[k], n corresponding second operating parts B[k], each of which has BIT(B) bits;
multiplying circuitry configured to obtain x partial products based on multiplying the x first encoded data Enc[m] with the n corresponding second operating parts;
accumulation circuitry configured to obtain an accumulation result based on accumulating the x partial products; and
truncation circuitry configured to obtain a multiplication result based on truncating the accumulation result,
wherein, n, k, x, and m are integers, and
wherein 0≤k<n, 0≤m<x.

8. The multiplier according to claim 7, wherein the first processing circuitry is configured to:
obtain the n first operands a[k] and setting the first operating part A, wherein:
the n first operands a[k] each have BIT(a[k]) bits and are signed numbers,
the first operating part A has BIT(A) bits, and
BIT(a[k]) is even and satisfies Σ₀ⁿ⁻¹BIT(a[k])≤BIT(A);
arrange the n first operands a[k] in descending order from largest to smallest according to a value of label k, wherein a first operand a[k] in a first position is adjacent to a first operand a[k−1] in a second position;
arrange the n first operands a[k] in descending order from highest bit a[k][BIT(a[k])−1] to lowest bit a[k][0];
start from a lowest bit in the BIT(A) bits of the first operating part A, inserting the first operand a[k] corresponding to the label k into each bit BIT(A[k]) of the BIT(A) bits in sequence;
determine a magnitude relationship between BIT(A) and a sum of bits of the n first operands Σ₀ⁿ⁻¹BIT(a[k]);
fill, based on Σ₀ⁿ⁻¹BIT(a[k]) being less than BIT(A), highest bit a[n−1][BIT(a[n−1])−1] of first operand a[n−1] as a sign bit before a highest bit a[n−1] of the n first operands; and
output the first operating part A based on Σ₀ⁿ⁻¹BIT(a[k]) being equal to BIT(A).

9. The multiplier according to claim 7, wherein the encoding circuitry is configured to:
determine parity of BIT(A);
supplement, based on BIT(A) being odd, highest bit a[n−1][BIT(a[n−1])−1] of the first operand a[n−1] as a sign bit before a highest bit of the first operating part A;
supplement, based on BIT(A) being even, 0 after a lowest bit of the first operating part A to obtain intermediate operand C which has BIT(C) bits;
from the BIT(C) bits of the intermediate operand C, continuously selecting three bits every two bits interval as the consecutive three-bit numbers to be encoded;
determine whether the consecutive three-bit numbers spans two consecutive first operands a[k] and a[k−1];
assign, based on the consecutive three-bit numbers spanning the two consecutive first operands a[k] and a[k−1], a lowest bit a[k−1][BIT(a[k])−1] in the consecutive three-bit numbers to 0; and
obtain, based on the consecutive three-bit numbers not spanning the two consecutive first operands a[k] and a[k−1], the x first encoded data Enc[m] based on:
referring to a Booth-encoding truth-value table, and
performing truth-value mapping on the consecutive three-bit numbers,
wherein, x=(BIT(A)+1)/2 based on BIT(A) being odd, and x=BIT(A)/2 based on BIT(A) being even.

10. The multiplier according to claim 7, wherein the second processing circuitry is configured to:
obtain the n second operands b[k] and setting the second operating part B[k] corresponding to each second operand b[k], wherein, the second operands b[k] each have BIT(b[k]) bits, and the second operating parts B[k] each have BIT(B) bits, and wherein BIT(b[k])≤BIT(B) when k=n−1, and BIT(b[k])+Σᵢ₌ₖⁿ⁻²BIT(a[i])≤BIT(B) when 0≤k≤n−2;
determine whether the second operand b[k] is a signed number;
supplement, based on the second operand b[k] being a signed number, 0 as a sign bit before a highest bit of the second operand b[k], and correspondingly adding 1 to the number of BIT(B) bits in the second operating part B[k];
determine, based on the second operand b[k] not being a signed number, a magnitude of k;
supplement, based on 0≤k≤n−2, Σᵢ₌ₖⁿ⁻²BIT(a[i]) 0 s after a lowest bit of the second operand b[k];
supplement, based on k=n−1, all bits before the highest bit of the second operand b[k] with sign bit b[k][BIT(b[k])−1]; and
output n second operating parts B[k].

11. The multiplier according to claim 7, wherein the multiplying circuitry is configured to:
query the consecutive three-bit numbers corresponding to the x first encoded data Enc[m] before performing truth-value mapping;
confirm the first operand a[k] corresponding to the consecutive three-bit numbers according to a value of the label k corresponding to each bit in the consecutive three-bit numbers;
determine whether the consecutive three-bit numbers spans two consecutive first operands a[k] and a[k−1];
specify, based on the consecutive three-bit numbers spanning two consecutive first operands a[k] and a[k−1], that the consecutive three-bit numbers correspond to the first operand a[k];
confirm, based on the consecutive three-bit numbers not spanning two consecutive first operands a[k] and a[k−1], the n second operating parts B[k] corresponding to the x first encoded data Enc[m] according to the first operands a[k] corresponding to the consecutive three-bit numbers; and
multiply the x first encoded data Enc[m] with the n second operating parts B[k] to obtain the x partial products.

12. The multiplier according to claim 7, wherein the truncation circuitry is configured to:
confirm the accumulation result has BIT(D) bits and a maximum number of bits BIT(E) for the multiplication result according to the BIT(A) and the BIT(B);
start from the lowest bit in BIT(D) bits of the accumulation result, and discarding Σᵢ₌₀ⁿ⁻²BIT(a[i]) bits;
start from the (Σᵢ₌₀ⁿ⁻²BIT(a[i])+1)-th bit in BIT(D) bits of the accumulation result, truncate a number of bits with the maximum number of bits BIT(E) from a low bit to a high bit as the multiplication result; and
output the multiplication result.

13. The multiplier according to claim 7, wherein the encoding circuitry comprises multiple encoders comprising zero clearing circuitry and mappers,
wherein first two bit numbers of the consecutive three-bit numbers are input into the mapper, and a last bit number is input into the zero clearing circuitry, and
wherein the last bit number is zeroed and a value of 0 is input into the mapper based on the consecutive three-bit numbers spanning two adjacent first operands a[k] and a[k−1], otherwise, an original value of the last bit number is input into the mapper.

14. The multiplier according to claim 7, wherein the second processing circuitry comprises multiple selection fillers,
wherein a selection filler is configured to process a second operand, and
wherein the multiple selection fillers are configured to synchronously or asynchronously process the second operand.

15. The multiplier according to claim 7, wherein the multiple selection fillers are configured to synchronously process the second operand, and
wherein the multiplier is configured to obtain the second operating part B[k] by filling the n second operands b[k] and selecting the second operand b[k] to be processed through the multiple selection fillers.

16. The multiplier according to claim 7, wherein the multiple selection fillers are configured to asynchronously process the second operand, and
wherein the multiplier is configured to obtain the second operating part B[k] by selecting the second operand b[k] to be processed, and filling the second operand b[k] through the corresponding selection filler.

17. A processor chip comprising a multiplier, wherein the multiplier comprises:
first processing circuitry configured to obtain, based on n first operands a[k], a first operating part A comprising BIT(A) bits;
encoding circuitry configured to obtain x first encoded data Enc[m] by assigning a lowest bit of consecutive three-bit numbers spanning two adjacent first operands a[k] and a[k−1] to 0, and performing Booth-encoding on the first operating part A;
second processing circuitry obtain, based on n second operands b[k], n corresponding second operating parts B[k], each of which has BIT(B) bits;
multiplying circuitry configured to obtain x partial products based on multiplying the x first encoded data Enc[m] with the n corresponding second operating parts;
accumulation circuitry configured to obtain an accumulation result based on accumulating the x partial products; and
truncation circuitry configured to obtain a multiplication result based on truncating the accumulation result,
wherein, n, k, x, and m are integers, and
wherein 0≤k<n, 0≤m<x.

18. The processor chip according to claim 17, wherein the encoding circuitry comprises multiple encoders comprising zero clearing circuitry and mappers,
wherein first two bit numbers of the consecutive three-bit numbers are input into the mapper, and a last bit number is input into the zero clearing circuitry, and
wherein the last bit number is zeroed and a value of 0 is input into the mapper based on the consecutive three-bit numbers spanning two adjacent first operands a[k] and a[k−1], otherwise, an original value of the last bit number is input into the mapper.

19. The processor chip according to claim 17, wherein the second processing circuitry comprises multiple selection fillers,
wherein a selection filler is configured to process a second operand, and
wherein the multiple selection fillers are configured to synchronously or asynchronously process the second operand.

20. The processor chip according to claim 17, wherein the multiple selection fillers are configured to synchronously process the second operand, and
wherein the multiplier is configured to obtain the second operating part B[k] by filling the n second operands b[k] and selecting the second operand b[k] to be processed through the multiple selection fillers.
